(19) United States
(12) Patent Application Publication
(10) Pub. No.: US 2006/0129558 A1
(43) Pub. Date: Jun. 15, 2006

(54) Method, system and program product for presenting exported hierarchical file system information

(75) Inventors: William Boyd Brown, Austin, TX (US); Rodney Carlton Burnett, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/011,247

(22) Filed: Dec. 14, 2004

(51) Int. Cl. G06F 17/30

(52) U.S. Cl. 707/10

(57) ABSTRACT

A technique for providing an accurate view of an exported file system structure. An in-memory filesystem is maintained as a combination of separate filesystems, each corresponding to a physical file system on the server. Directories in the in-memory, or pseudo, filesystems are also coupled with an existing directory in the physical filesystems on the server which is exporting the file system(s) or portions thereof. This allows the server to present a filesystem tree to a client which includes the files explicitly exported by a system administrator, and also maintain the device and attributes information of each file regardless of it being an actual file in the physical filesystem or a node in the in-memory pseudo filesystem. Clients can thus view the exported filesystem tree as a collection of filesystems. For each filesystem seen by the client, each file/directory will depict the same set of attributes and operations as are available on the exporting server.

### BACKGROUND OF THE INVENTION

1. Technical Field

The present invention relates to management of file systems in a data processing system, and in particular relates to providing improved hierarchical and status information for exported file systems.

2. Description of Related Art

Network file system (NFS) is a client-server application that allows network users to access shared files stored on computer systems of different types. Users can manipulate shared files as if they were stored locally (i.e., on the users' own hard disk). With NFS, computer systems connected to a network operate as clients when accessing remote files and as servers when providing remote users access to local shared files. A representative system is shown at 100 in FIG. 1. A client data processing system 102 is operably coupled to a server data processing system 104 via network 106. When a file is accessed by an application or management program/process, a call is made to system call layer 108. The system call layer 108 then calls the virtual file system (VFS) layer 110, which calls either the local file system interface 112 or the NFS client 114 depending upon whether the desired file is local to this client or remote. If local, the file is accessed from a local storage media such as that shown at 116. If remote, the NFS client 114 calls the RPC client stub 118 to initiate remote file access across network 106.

Server 104 similarly contains a system call layer 120, which may be called by an application or management program/process running within server 104. In similar fashion to that described above with respect to the client, the system call layer 120 calls the virtual file system (VFS) layer 122, which in turn calls the local file system interface 124 for access to local files stored on storage media 126. Server 104 also contains an RPC server stub 130 which receives commands/signals from RPC client stub 118 across network 106. The RPC server stub 130 calls the NFS server 128 within server 104, which then accesses the VFS layer 122 for access to the file stored locally on storage media 126 by way of local file system interface 124. These NFS standards are publicly available and widely used.

NFS uses a hierarchical file system, with directories as all but the bottom level of files. Each entry in a directory (file, directory, device, etc.) has a string name. A pathname is a concatenation of all the components (directory and file names) in the name. A file system is a tree on a single server (usually a single disk or physical partition) with a specified root directory.

Some operating systems provide a “mount” operation that makes all file systems appear as a single tree, while others maintain a multiplicity of file systems. To mount a file system is to make the file system available for use at a specified location, the mount point. To use an analogy, suppose there is a tree that contains a plurality of branches, as most trees do, but the branches are not attached to the tree. Upon startup, some operating systems attach each branch of the tree at its proper location (the mount point) on the tree. Other operating systems, however, do not attach the branches to the tree on startup but instead leave them in their storage place. Each branch, in this case, is referred to as a file system.

Some computer systems, especially those running a Microsoft operating system such as Windows, generally attach all the branches to the tree on startup. However, Unix-based computer systems typically do not do so. They only attach certain branches to the tree on startup. These attached branches (or file systems or directories) are the ones that contain files that are critical for the operating system to function properly. The other file systems are mounted only when needed.

One particular time a file system is mounted is just before the file system is exported. To export a file system is to make the file system available for NFS clients to mount (i.e., to attach the branch to their own tree). When exporting a file system, the mount point as well as the name of the storage device containing the file system must be provided (i.e., the name of the branch and the location on the tree where the branch is to be attached must be provided). If the file system is mounted, all the needed information is known; hence, the reason why file systems are mounted before they are exported.

Referring now to FIG. 2, there is shown at 200 a system having a server 202 along with clients 204 and 206 operatively coupled to such server by way of network 208. Server 202 has a file system 210 having a root node 212 and a plurality of other nodes. As described above, nodes other than the bottom node are directories, and representative examples are shown by the directories labeled “users” and “bin” within server 202. In this example, a directory structure 214 is desired to be used by client A 204 and client B 206. Instead of physically transferring or copying this directory structure 214 to each of clients 204 and 206, an alternative approach is to export this directory structure 214 by server 202. This exported directory structure can then be mounted within each client's respective file system 220 and 230, as shown at 216 within client 204 and at 218 within client 206.

Most Unix-based servers contain a great number of file systems. Due to design limitations, all the file systems may not be mounted simultaneously. Hence, a lot of these servers adopt a policy of mounting file systems when they are needed and of dismounting or unmounting them unless they are used within a pre-defined amount of time. This allows for other file systems to be mounted if needed.

An inode is an internal structure that describes an individual file (e.g. regular, directory, symbolic link, etc). An inode contains file size and update information, as well as the addresses of data blocks, or in the case of large files, indirect blocks that, in turn, point to data blocks. One inode is required for each file. A file system identifier, or fsid, is a unique identifier associated with each file system. Similarly, a file handle, or fh, is a unique identifier associated with each file. A vnode is similar to an inode, but rather than being an internal structure that describes an individual file, a vnode is an internal structure used by a virtual file system (VFS) for describing a virtual file, and thus insulates physical file characteristics from the particular application accessing the file using VFS.

Certain versions of NFS require that the server provide a root node to which each client can access, even though this root node is not necessarily exported by the server. Providing such a root node allows users on a client system to traverse a file system hierarchy that contains exported file systems or portions thereof even though the entire file system hierarchy may not have been exported to such client. For example, as shown at 300 in FIG. 3, a portion of a server file system is shown at 302, and the directories vol0, vol1 and archive (shown as bolded and by solid line connection to their respective parent directory) are to be exported from a server to a client. These directories to be exported are only a portion of the overall server file system. For example, other portions of the file system such as directories vol, admin, backup and vol2 are not exported to the client. This can be seen at server view 302. On the client side, the exported directories can be seen when viewing client view 304, where exported directories vol0, vol1 and archive are shown at the bottom of the triangle. Because of an NFS requirement to provide a root node for exported directories to which the client can access, a pseudo filesystem is created for the client, the pseudo filesystem containing pseudo nodes between exported directories and the requisite root node, such as node 306. These pseudo-nodes are shown within the triangle as “vol” and “backup” and provide a hierarchical path from the exported directories vol0, vol1, and archive up to the root node 306, thereby allowing a user to “see” how the exported files are hierarchically organized within the server notwithstanding that some intervening nodes/directories have not been exported by the server.

A problem exists within current pseudo-filesystem implementations, in that a separate in-memory filesystem is maintained to provide the paths from the root node to the exported nodes. Clients see the nodes in the in-memory filesystem as directories, but with attributes that have little or no relationship to the corresponding directory in the physical filesystem on the server.

It would thus be desirable to provide a technique for exporting a file system, or portion thereof, which includes a root node as well as current directory/attribute information for intervening, non-exported directories that are a part of the pseudo-file system viewable by a client.

### SUMMARY OF THE INVENTION

A method, system and computer program product for providing an accurate view of an exported file system structure. An in-memory filesystem is maintained as a combination of separate filesystems, each corresponding to a physical file system on the server. Directories in the in-memory, or pseudo, filesystems are also coupled with an existing directory in the physical filesystems on the server which is exporting the file system(s) or portions thereof. This allows the server to present a filesystem tree to a client which includes the files explicitly exported by a system administrator, and also maintain the device and attributes information of each file regardless of it being an actual file in the physical filesystem or a node in the in-memory pseudo filesystem. Clients can thus view the exported filesystem tree as a collection of filesystems. For each filesystem seen by the client, each file/directory will depict the same set of attributes and operations as are available on the exporting server.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a client server model that supports a shared filed system.

FIG. 2 depicts an example of exporting a file system from a server data processing system to a plurality of client data processing systems.

FIG. 3 depicts server and client views of an exported file system.

FIG. 4 depicts a pictorial representation of a network of data processing systems.

FIG. 5 depicts a block diagram of a data processing system that may be implemented as a server.

FIG. 6 depicts a block diagram of a data processing system that may be implemented as a client.

FIG. 7 depicts the data structure of a pseudo file system node (pfsnode).

FIG. 8 depicts the data structure of a virtual node (vnode).

FIG. 9 depicts a process for finding a pseudo-node for a physical node.

FIG. 10 depicts a process for looking up a child node of a parent node.

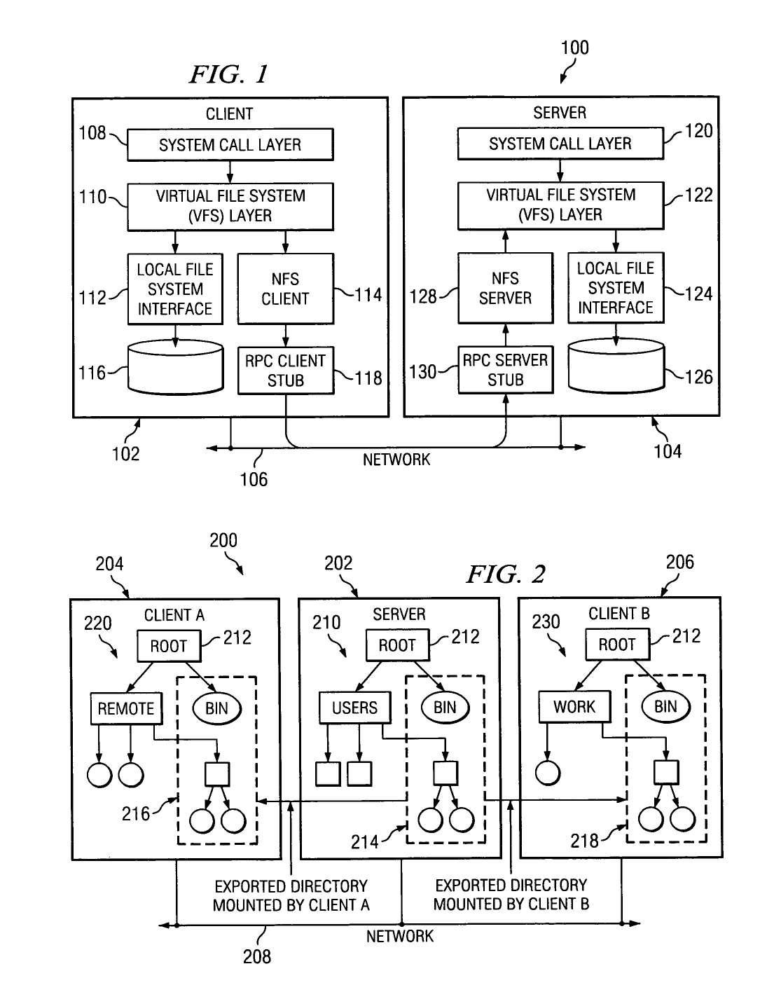

### DETAILED DESCRIPTION OF THE PREFERRED EMBODIMENT

FIG. 4 depicts a pictorial representation of a network of data processing systems in which the present invention may be implemented. Network data processing system 400 is a network of computers in which the present invention may be implemented. Network data processing system 400 contains a network 402, which is the medium used to provide communications links between various devices and computers connected together within network data processing system 400. Network 402 may include connections, such as wire, wireless communication links, or fiber optic cables.

In the depicted example, server 404 is connected to network 402 along with storage unit 406. In addition, clients 408, 410, and 412 are connected to network 402. These clients 408, 410, and 412 may be, for example, personal computers or network computers. In the depicted example, server 404 provides data, such as boot files, operating system images, exported files/directories and applications to clients 408-412. Clients 408, 410, and 412 are clients to server 404. Network data processing system 400 may include additional servers, clients, and other devices not shown. In the depicted example, network data processing system 400 utilizes the Internet with network 402 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 400 also may be implemented as a number of different types of networks, such as for example, an intranet, a local area network (LAN), or a wide area network (WAN). FIG. 4 is intended as an example, and not as an architectural limitation for the present invention.

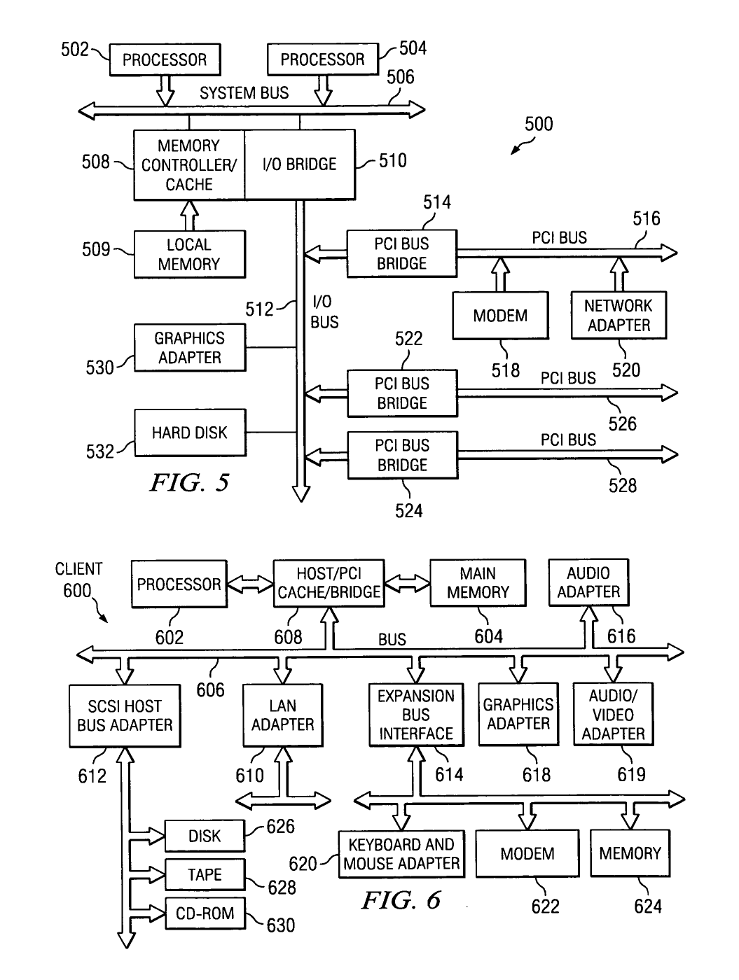

Referring to FIG. 5, a block diagram of a data processing system that may be implemented as a server, such as server 404 in FIG. 4, is depicted in accordance with a preferred embodiment of the present invention. Data processing system 500 may be a symmetric multiprocessor (SMP) system including a plurality of processors 502 and 504 connected to system bus 506. Alternatively, a single processor system may be employed. Also connected to system bus 506 is memory controller/cache 508, which provides an interface to local memory 509. I/O bus bridge 510 is connected to system bus 506 and provides an interface to I/O bus 512. Memory controller/cache 508 and I/O bus bridge 510 may be integrated as depicted.

Peripheral component interconnect (PCI) bus bridge 514 connected to I/O bus 512 provides an interface to PCI local bus 516. A number of modems may be connected to PCI local bus 516. Typical PCI bus implementations will support four PCI expansion slots or add-in connectors. Communications links to clients 408-412 in FIG. 4 may be provided through modem 518 and network adapter 520 connected to PCI local bus 516 through add-in boards.

Additional PCI bus bridges 522 and 524 provide interfaces for additional PCI local buses 526 and 528, from which additional modems or network adapters may be supported. In this manner, data processing system 500 allows connections to multiple network computers. A memory-mapped graphics adapter 530 and hard disk(s) 532 may also be connected to I/O bus 512 as depicted, either directly or indirectly.

Those of ordinary skill in the art will appreciate that the hardware depicted in FIG. 5 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 5 may be, for example, an IBM eServer pSeries system, a product of International Business Machines Corporation in Armonk, N.Y., running the Advanced Interactive Executive (AIX) operating system or LINUX operating system.

With reference now to FIG. 6, a block diagram illustrating a data processing system is depicted in which the present invention may be implemented. Data processing system 600 is an example of a client computer. Data processing system 600 employs a peripheral component interconnect (PCI) local bus architecture. Although the depicted example employs a PCI bus, other bus architectures such as Accelerated Graphics Port (AGP) and Industry Standard Architecture (ISA) may be used. Processor 602 and main memory 604 are connected to PCI local bus 606 through PCI bridge 608. PCI bridge 608 also may include an integrated memory controller and cache memory for processor 602. Additional connections to PCI local bus 606 may be made through direct component interconnection or through add-in boards. In the depicted example, local area network (LAN) adapter 610, SCSI host bus adapter 612, and expansion bus interface 614 are connected to PCI local bus 606 by direct component connection. In contrast, audio adapter 616, graphics adapter 618, and audio/video adapter 619 are connected to PCI local bus 606 by add-in boards inserted into expansion slots. Expansion bus interface 614 provides a connection for a keyboard and mouse adapter 620, modem 622, and additional memory 624. Small computer system interface (SCSI) host bus adapter 612 provides a connection for hard disk drive 626, tape drive 628, and CD-ROM drive 630. Typical PCI local bus implementations will support three or four PCI expansion slots or add-in connectors.

An operating system runs on processor 602 and is used to coordinate and provide control of various components within data processing system 600 in FIG. 6. The operating system may be a commercially available operating system, such as Windows XP, which is available from Microsoft Corporation. An object oriented programming system such as Java may run in conjunction with the operating system and provide calls to the operating system from Java programs or applications executing on data processing system 600. “Java” is a trademark of Sun Microsystems, Inc. Instructions for the operating system, the object-oriented operating system, and applications or programs are located on storage devices, such as hard disk drive 626, and may be loaded into main memory 604 for execution by processor 602.

Those of ordinary skill in the art will appreciate that the hardware in FIG. 6 may vary depending on the implementation. Other internal hardware or peripheral devices, such as flash read-only memory (ROM), equivalent nonvolatile memory, or optical disk drives and the like, may be used in addition to or in place of the hardware depicted in FIG. 6. Also, the processes of the present invention may be applied to a multiprocessor data processing system.

As another example, data processing system 600 may be a stand-alone system configured to be bootable without relying on some type of network communication interface. As a further example, data processing system 600 may be a personal digital assistant (PDA) device, which is configured with ROM and/or flash ROM in order to provide non-volatile memory for storing operating system files and/or user-generated data.

The depicted example in FIG. 6 and above-described examples are not meant to imply architectural limitations. For example, data processing system 600 also may be a notebook computer or hand held computer in addition to taking the form of a PDA. Data processing system 600 also may be a kiosk or a Web appliance.

The present invention facilitates the exporting of a file system, or portion thereof, by a server data processing system (such as server 404 shown in FIG. 4) for use by a client system(s) (such as client 408, 410 and 412 shown in FIG. 4). The present invention advantageously provides an accurate hierarchical arrangement of files and/or directories for such exported file system when a root node depiction, which may or may not be an explicit part of the export operation, is included as a part of the export operation in order to comply with filesystem (or other types of) standards or requirements. An in-memory filesystem is maintained as a combination of separate filesystems, each corresponding to an exported node of a physical filesystem on the server. Directories in the in-memory, or pseudo, filesystems are also coupled with an existing directory in the physical filesystems. This allows the server to present a filesystem tree to the client which includes the files explicitly exported by the system administrator or application, and also maintain the device and attribute information of each file regardless of it being an actual file in the physical filesystem or a node in the in-memory pseudo filesystem. Clients can view the exported filesystem tree as a collection of filesystems. For each filesystem seen by the client, each file will have the same set of attributes and operations as they exist on the server where the physical filesystem is maintained.

In order to implement the above described combination of pseudo filesystems and the coupling of such pseudo filesystems with the physical filesystem(s), the vnode of the directories in the physical filesystems have been augmented to include additional flags. The first flag indicates whether this directory in the physical file system is associated with, or covered by, a directory node in the pseudo filesystem. A second flag indicates whether this directory in the physical file system is the root node of an exported filesystem.

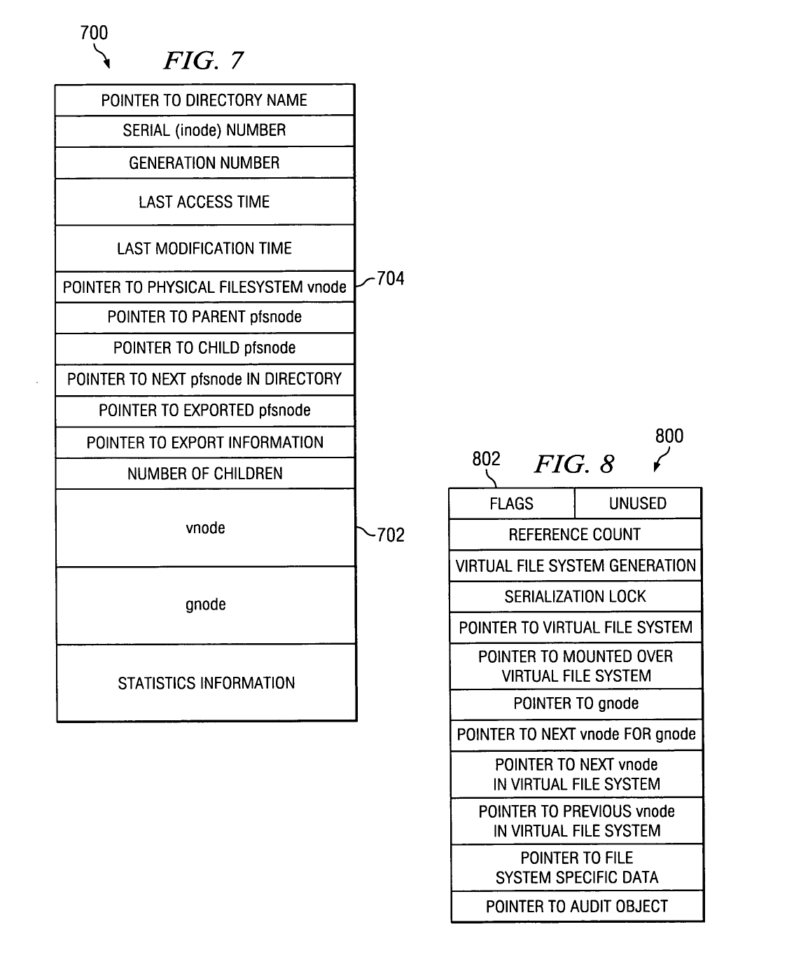

As is traditional, each node in a pseudo filesystem is represented by a data structure called a pfsnode. FIG. 7 shows such a pfsnode at 700. The pfsnode contains information needed to perform basic operations on the pseudo filesystem (such as lookup and readdir), including the name of the directory, the location of the directory's parent and children, and the serial and generation numbers of the directory. The serial and generation numbers are identical to those of the physical directory covered by the pfsnode.

The pfsnode also contains the location of an internal VFS structure, such as is shown in FIG. 7 as vnode 702. This VFS structure is shared by each pfsnode representing directories in a single physical filesystem. The pfsnode also contains the location of the vnode of the covered directory in the physical filesystem, such as is shown at element 704 of FIG. 7. The contents of such a vnode are shown at 800 in FIG. 8. This is a modification of a traditional vnode, and uses a portion 802 of a previously unused 16-bit field to include the above described two new flags. All other data fields within this vnode 800 are standard known fields. It would also be possible to maintain these two new flags elsewhere without departing from the scope of the present invention described herein.

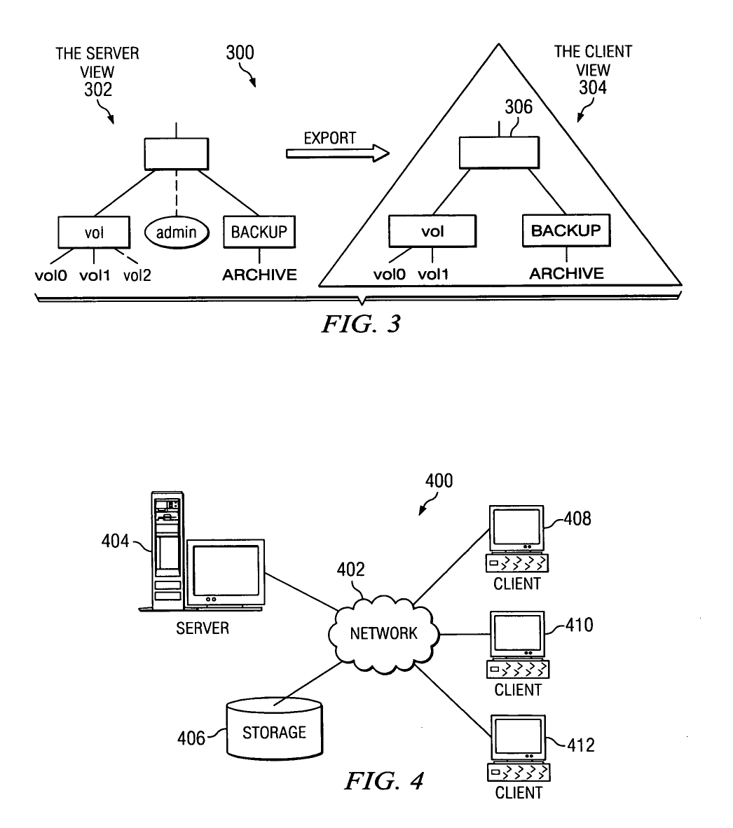

As file systems are exported, pfsnodes are created to provide a path from the root node to each exported node, the path including intervening nodes that may not have been exported. For example, referring to FIG. 3, a pfsnode is created for directory vol (which was not exported) to provide a path from root node 306 to exported directories vol0 and vol1. Similarly, a pfsnode is created for directory BACKUP (which was not exported) to provide a path from root node 306 to exported directory ARCHIVE. A pfsnode is not created, in the preferred embodiment, for directory admin (which was not exported), as this is not an intervening node between root node 306 and an exported node and thus is not needed to provide a path between the root node and an exported node. As file systems are unexported, pfsnodes are destroyed.

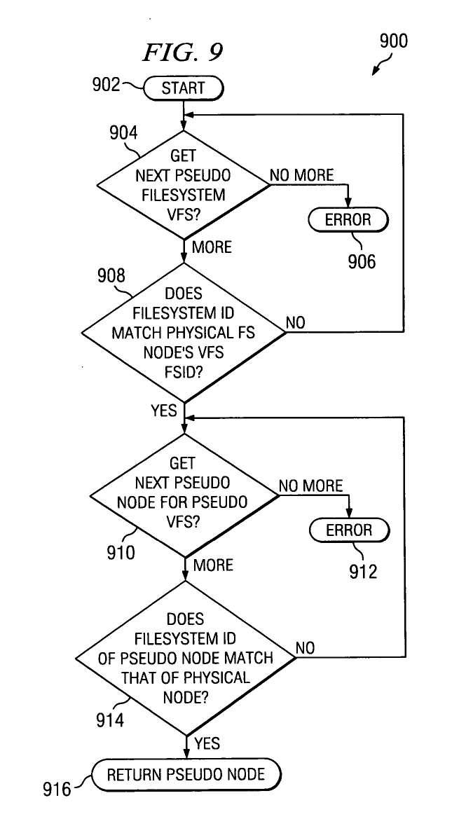

Given a directory in the physical file system, the covering pfsnode can be obtained by locating the pseudo filesystem's VFS structure which corresponds to the VFS structure of the physical directory. From the pseudo filesystem's VFS structure, the pfsnode can be located by comparing the serial and generation numbers of the VFS′ pfsnode with those of the physical directory. This will be further described below with respect to FIG. 9. Locating a physical directory associated with a pfsnode is done by following the reference to the directory's vnode, such as vnode 702 in FIG. 7, which is maintained in the pfsnode.

FIG. 9 depicts at 900 a process for finding an associated or covering pseudo-node for a physical node. This process may be invoked by a server to create an in-memory filesystem which is maintained as a combination of separate filesystems, each corresponding to an exported node of a physical filesystem on the server. The process begins at 902, and proceeds to 904 where the next VFS pseudo-filesystem is gotten. If no more VFS pseudo-file systems exist, the process terminates with an error at 906. If retrieval of the next VFS pseudo-filesystem is successful at 904, processing continues at 908 where a determination is made as to whether the pseudo-filesystem ID matches the physical filesystem node's VFS filesystem ID (FSID). If no, processing returns to block 904 to get the next pseudo-filesystem VFS. If yes, processing proceeds to block 910 where the next pseudo-node for the matched pseudo-filesystem is retrieved. If no more pseudo-nodes for the matched pseudo-filesystem exist, the process terminates with an error at 912. If retrieval of the next pseudo-node for the pseudo-filesystem is successful at 910, processing continues at 914 where a determination is made as to whether the fileID of the pseudo-node matches the fileID of the physical node. If no, processing returns to block 910 to get the next pseudo-node for the pseudo-VFS. If yes, processing proceeds to block 916 where the pseudo-node is returned to the calling or invoking process/procedure/routine.

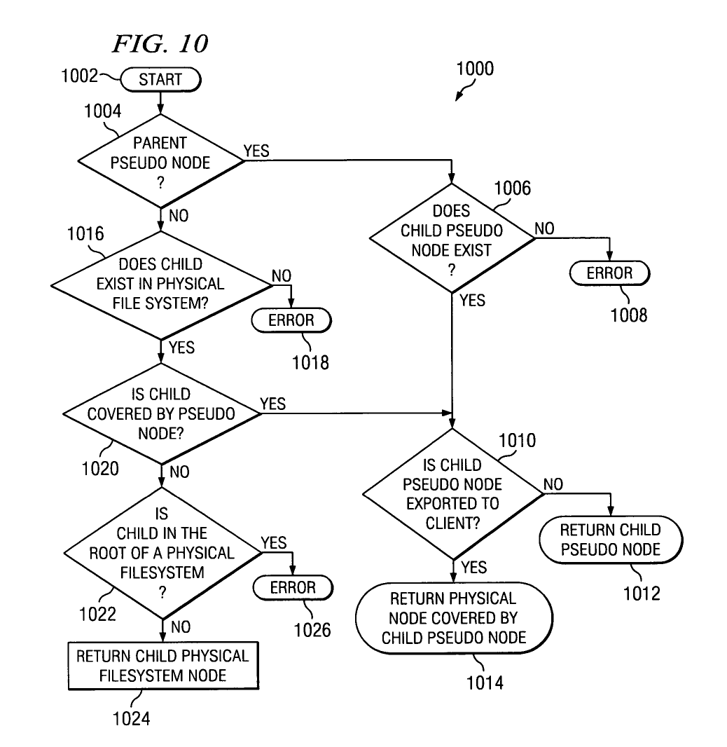

For directories which are the root of an exported filesystem, as indicated by the second new pfsnode flag previously described, the covering pfsnodes will contain access information for the exported filesystem. Lists of exported file systems are no longer needed per the present invention since the information is contained with the pfsnodes of the pseudo filesystem. When processing a lookup operation requested by a client, the server uses this information to determine (1) if the result of the lookup is exported and (2) if the client has access to that exported filesystem. If the result of the lookup is not exported, the request will fail. If the result of the lookup is exported, the file handle returned to the client will either be that of the file in the physical filesystem (the client has access to the exported filesystem) or that of the pfsnode in the pseudo filesystem (the client does not have access to the exported filesystem). This will be further described in detail below with reference to FIG. 10. Client requests to lookup the parent of a directory are processed the same way.

FIG. 10 depicts at 1000 a process for looking up a child node of a parent node. The process begins at 1002, and proceeds to 1004 where it is determined if the current node is a parent pseudo-node. If yes, processing continues to 1006 where a determination is made as to whether a child pseudo-node exists for this parent pseudo-node. If no, an error condition is indicated at 1008 as there is no corresponding child node, and processing terminates. The client will receive a failure indication since the filesystem is exported, but the client does not have access to it and there are no other exported filesystems below this one. If yes, processing continues to 1010 where it is determined if this is a child pseudo-node that is exported to a client. If no, this child pseudo-node is returned as this in an intervening node that is returned to provide a path to an exported directory further down in the filesystem system tree which the client may have access to. Processing then terminates at 1012. If this child pseudo-node is exported to a client, processing proceeds to 1014 where the physical node covered by this child pseudo-node is returned (the physical node is returned because the client has access to it).

Returning back to block 1004, if it is determined that the current node is not a parent pseudo-node, then this node is a parent node in the physical file system and processing proceeds to 1016 where a determination is made as to whether a corresponding child node exists in the physical file system. If no, an error condition is indicated at 1018 as there is no corresponding child node, and processing terminates. In this situation, the client tried to look up a file or directory that does not exist (either physical or pseudo). If yes, processing continues to 1020 where a determination is made as to whether this physical child node is covered by a pseudo-node. If no, the child physical filesystem node is returned at 1022. If yes, processing proceeds to block 1010 and continues as previously described regarding child pseudo-node processing.

When processing ‘readdir’ requests, the server uses the same logic as in the ‘lookup’ process that was previously described to determine which files (physical filesystem files of pseudo filesystem pfsnodes) should be used for each directory entry or node in the ‘lookup’ reply. When returning file attributes for a pfsnode, the server uses the attributes of the covered vnode. For filesystem attributes, the attributes of the physical filesystem of the covered vnode are used. This presents the client with a filesystem tree which is identical to the physical filesystem, but only contains the files which are exported.

As can be seen by the above description, the present invention presents to the client a filesystem tree which reflects the physical filesystem, including current file/directory device and attribute information, while enforcing the access restrictions of the exported directories.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In a system comprising a server data processing system and a server file system maintained by the server data processing system, wherein the server data processing system comprises a server in-memory representation of the server file system, a method comprising steps of:
exporting a portion of the server file system;
generating a client in-memory representation of the exported file system, the client in-memory representation including a pseudo-node for a non-exported portion of the server file system; and
associating the server in-memory representation with the client in-memory representation, wherein at least one attribute for the non-exported portion of the server file system is linked to the pseudo-node of the client in-memory representation.

2. The method of claim 1, wherein the non-exported portion is a non-exported directory.

3. The method of claim 1, wherein the non-exported portion is a plurality of non-exported directories, and wherein the client in-memory representation includes a plurality of pseudo-nodes, with each one of the plurality of pseudo-nodes being associated with a corresponding non-exported directory of the plurality of non-exported directories.

4. The method of claim 1, wherein the system further comprises a client data processing system and wherein the portion of the server file system is exported to the client data processing system, and further comprising a step of providing the at least one attribute to the client data processing system responsive to a filesystem command by the client data processing system.

5. The method of claim 4, wherein the filesystem command initiates an action of lookup directory or read directory.

6. A data structure resident in a memory of a data processing system, the data structure comprising information pertaining to a given directory in a file system within the data processing system, and further comprising:
a first indicia indicating whether the given directory is associated with a node in a pseudo filesystem that is maintained for access by another data processing system; and
a second indicia indicating whether the given directory is a root node of the file system and at least a portion of the file system has been exported to the another data processing system.

7. An apparatus, comprising:
a physical file system and an associated in-memory representation of the physical file system; and
a plurality of pseudo-nodes, each one of the pseudo-nodes corresponding to a respective node of the physical file system and linked to the physical file system to provide current attribute information pertaining to the physical file system.

8. The apparatus of claim 7, wherein a plurality of nodes of the physical file system are exported and wherein at least one node of the physical file system is not exported, and wherein at least one of the plurality of pseudo-nodes is accessible to provide current attribute information for the at least one non-exported node.

9. The apparatus of claim 8, wherein the at least one non-exported node is a non-exported directory.

10. A system comprising a server data processing system and a server file system maintained by the server data processing system, wherein the server data processing system comprises a server in-memory representation of the server file system, the system comprising:
means for exporting a portion of the server file system;
means for generating a client in-memory representation of the exported file system, the client in-memory representation including a pseudo-node for a non-exported portion of the server file system; and
means for associating the server in-memory representation with the client in-memory representation, wherein at least one attribute for the non-exported portion of the server file system is linked to the pseudo-node of the client in-memory representation.

11. The system of claim 10, wherein the non-exported portion is a non-exported directory.

12. The system of claim 10, wherein the non-exported portion is a plurality of non-exported directories, and wherein the client in-memory representation includes a plurality of pseudo-nodes, with each one of the plurality of pseudo-nodes being associated with a corresponding non-exported directory of the plurality of non-exported directories.

13. The system of claim 10, further comprising a client data processing system, wherein the portion of the server file system is exported to the client data processing system, the system further comprising:
means for providing the at least one attribute to the client data processing system responsive to a filesystem command by the client data processing system.

14. The system of claim 13, wherein the filesystem command initiates an action of lookup directory or read directory.

15. A system comprising a server data processing system and a server file system maintained by the server data processing system, wherein the server data processing system comprises a server in-memory representation of the server file system, and wherein the server data processing system (i) exports a portion of the server file system; (ii) generates a client in-memory representation of the exported file system, the client in-memory representation including a pseudo-node for a non-exported portion of the server file system; and (iii) associates the server in-memory representation with the client in-memory representation, wherein at least one attribute for the non-exported portion of the server file system is linked to the pseudo-node of the client in-memory representation.

16. The system of claim 15, further comprising a client data processing system, wherein the portion of the server file system is exported to the client data processing system, and wherein the server data processing system provides the at least one attribute to the client data processing system responsive to a filesystem command by the client data processing system.

17. A computer program product in a computer readable medium for use in a data processing system, comprising:
instructions for exporting a portion of a file system maintained by the data processing system;
instructions for generating an in-memory representation of the exported file system, the in-memory representation including a pseudo-node for a non-exported portion of the file system; and
instructions for associating the file system with the in-memory representation, wherein at least one attribute for the non-exported portion of the file system is linked to the pseudo-node of the in-memory representation to provide current attribute information pertaining to the non-exported portion.

18. A computer program product in a computer readable medium for use in a data processing system, the computer program product comprising a data structure, the data structure comprising information pertaining to a given directory in a file system within the data processing system, a first indicia indicating whether the given directory is associated with a node in a pseudo filesystem that is maintained for access by another data processing system, and a second indicia indicating whether (i) the given directory is a root node of the file system and (ii) at least a portion of the file system has been exported to the another data processing system.
